(19) United States
(12) Patent Application Publication
(10) Pub. No.: US 2017/0155124 A1
(43) Pub. Date: Jun. 1, 2017

(54) NONAQUEOUS ELECTROLYTE SECONDARY BATTERY SEPARATOR, NONAQUEOUS ELECTROLYTE SECONDARY BATTERY LAMINATED SEPARATOR, NONAQUEOUS ELECTROLYTE SECONDARY BATTERY MEMBER, AND NONAQUEOUS ELECTROLYTE SECONDARY BATTERY

(71) Applicant: Sumitomo Chemical Company, Limited, Tokyo (JP)

(72) Inventor: Takahiro OKUGAWA, Niihama-shi (JP)

(21) Appl. No.: 15/297,182

(22) Filed: Oct. 19, 2016

(30) Foreign Application Priority Data
Nov. 30, 2015 (JP) 2015-233934

(51) Int. Cl. H01M 2/18; H01M 2/14; H01M 2/16; H01M 10/0525

(52) U.S. Cl. CPC H01M 2/18; H01M 10/0525; H01M 2/145; H01M 2/1653

(57) ABSTRACT

Provided is a nonaqueous electrolyte secondary battery separator excellent in slip characteristics with respect to pins and in cutting processibility. The nonaqueous electrolyte secondary battery separator is a porous film containing polyolefin as a major component, and has a thickness of 20 μm or less and a porosity of 20% to 55%. A minimum height from which a ball, with a diameter of 14.3 mm and a weight of 11.9 g, is made to free-fall on the porous film, so that the porous film is caused to be torn, is not less than 50 cm.

This Nonprovisional application claims priority under 35 U.S.C. §119 on Patent Application No. 2015-233934 filed in Japan on Nov. 30, 2015, the entire contents of which are hereby incorporated by reference.

### TECHNICAL FIELD

The present invention relates to a separator for a nonaqueous electrolyte secondary battery (hereinafter referred to as a “nonaqueous electrolyte secondary battery separator”), a laminated separator for a nonaqueous electrolyte secondary battery (hereinafter referred to as a “nonaqueous electrolyte secondary battery laminated separator”), a member for a nonaqueous electrolyte secondary battery (hereinafter referred to as a “nonaqueous electrolyte secondary battery member”), and a nonaqueous electrolyte secondary battery.

### BACKGROUND ART

Nonaqueous electrolyte secondary batteries, especially lithium secondary batteries, have high energy density and have thus been widely employed as batteries for personal computers, mobile phones, portable information terminals, electric vehicles, and the like. Particularly, lithium secondary batteries have recently been employed by electric vehicles and the like. This causes a continuously particular increase in production volume. Under the circumstances, there have been demands for improving (i) deficiencies during manufacturing lithium secondary batteries and (ii) yields of manufactured lithium secondary batteries.

In order to improve yields of the manufactured lithium secondary batteries, excellent slip characteristics are demanded for a separator which is to be provided between a cathode and an anode of a nonaqueous electrolyte secondary battery. In nonaqueous electrolyte secondary batteries of winding-type such as cylindrical type or angular type, a cathode, a separator, and an anode are combined and wound around a pin. Subsequently, the pin is removed from a spiral battery element, so that a battery is assembled. In so doing, the pin cannot be easily removed from a separator if the separator, which is in contact with the pin, has inadequate slip characteristics. This ultimately causes a reduction in battery productivity. In order to improve the slip characteristics of a separator with respect to pins, Patent Literature 1 discloses a technique in which a surface of a pin is treated so as to reduce a friction coefficient of that pin. Patent Literature 2 discloses a technique of reducing a static friction coefficient of a separator.

### CITATION LIST

### Patent Literatures

Patent Literature 1

Japanese Patent Application Publication Tokukai No. 2009-070726 (Publication date: Apr. 2, 2009)

Patent Literature 2

Japanese Patent Application Publication Tokukai No. 2011-126275 (Publication date: Jun. 30, 2011)

### SUMMARY OF INVENTION

### Technical Problem

In order to increase yields of the manufactured lithium secondary batteries, not only slip characteristics but also culling processibility in demanded for the separator. This is because a separator that has inadequate cutting processibility cannot be properly cut into a desired size. Such a separator may be torn in an unintended direction during cutting process, and/or a cutting blade of a separator-cutting machine may need to be frequently replaced. This causes a reduction in production volume of lithium secondary batteries. Nevertheless, the cutting processibility has not yet been considered in Patent Literatures 1 and 2.

The present invention has been attained in view of the above problems, and an object of the present invention is to provide a nonaqueous electrolyte secondary battery separator, a nonaqueous electrolyte secondary battery laminated separator, a nonaqueous electrolyte secondary battery member, and a nonaqueous electrolyte secondary battery each of which is excellent in slip characteristics with respect to pins and in cutting processibility.

### Solution to Problem

The inventor of the present invention has accomplished the present invention by finding for the first time that a minimum height from which a ball, with a diameter of 14.3 mm and a weight of 11.9 g, is made to free-fall on the porous film or the nonaqueous electrolyte secondary battery laminated separator, so that the porous film or the nonaqueous electrolyte secondary battery laminated separator is caused to be torn, is correlated to (i) slip characteristic with respect to pins and (ii) cutting processability.

A nonaqueous electrolyte secondary battery separator in accordance with an embodiment of the present invention is a porous film containing polyolefin as a major component, the porous film having a thickness of 20 μm or less and having a porosity of 20% to 55%, a minimum height from which a ball, with a diameter of 14.3 mm and a weight of 11.9 g, is made to free-fall on the porous film, so that the porous film is caused to be torn, being not less than 50 cm.

The nonaqueous electrolyte secondary battery laminated separator in accordance with an embodiment of the present invention includes: a nonaqueous electrolyte secondary battery separator mentioned above; and a porous layer.

A nonaqueous electrolyte secondary battery laminated separator in accordance with an embodiment of the present invention includes a porous film and a porous layer, the porous film containing polyolefin as a major component, the porous film having a thickness of 20 μm or less and having a porosity of 20% to 55%, a minimum height from which a ball, with a diameter of 14.3 mm and a weight of 11.9 g, is made to free-fall on the nonaqueous electrolyte secondary battery laminated separator, so that the nonaqueous electrolyte secondary battery laminated separator is caused to be torn, being not less than 50 cm.

A nonaqueous electrolyte secondary battery member in accordance with an embodiment of the present invention includes: a cathode; a nonaqueous electrolyte secondary battery separator mentioned above or a nonaqueous electrolyte secondary battery laminated separator mentioned above; and an anode, the cathode, the nonaqueous electrolyte secondary battery separator or the nonaqueous electrolyte secondary battery laminated separator, and the anode being provided in this order.

The nonaqueous electrolyte secondary battery in accordance with an embodiment of the present invention includes a nonaqueous electrolyte secondary battery separator mentioned above or a nonaqueous electrolyte secondary battery laminated separator mentioned above.

### Advantageous Effects of Invention

The present invention provides a nonaqueous electrolyte secondary battery separator or a nonaqueous electrolyte secondary battery laminated separator that are excellent in slip characteristics with respect to pins and in cutting processibility.

### BRIEF DESCRIPTION OF DRAWINGS

FIG. 1 illustrates a jig used in a falling-ball test.

FIG. 2 illustrates how to evaluate cutting processibility.

FIG. 3 illustrates a bottom and a side surface of a sleigh member for measuring pin pull-out resistance.

FIG. 4 illustrates how to measure pin pull-out resistance.

FIG. 5 illustrates a measurement result of surface roughness (friction coefficient) of a mirror-finished ball, which measurement result is obtained by using a non-contact surface measurement system.

FIG. 6 illustrates a measurement result of surface roughness (friction coefficient) of a non-mirror-finished ball, which measurement result is obtained by using the non-contact surface measurement system.

### DESCRIPTION OF EMBODIMENTS

The description below will discuss embodiments of the present invention. The present invention is, however, not limited to such embodiments. That is, the present invention is not limited to configurations described below, but can be altered by a skilled person in the art within the scope of the claims. An embodiment derived from a proper combination of technical means each disclosed in a different embodiment is also encompassed in the technical scope of the present invention. In the present specification, any numerical range expressed as “A to B” means “not less than A and not greater than B” unless otherwise stated.

### Embodiment 1

[1. Nonaqueous Electrolyte Secondary Battery Separator]

A nonaqueous electrolyte secondary battery separator (hereinafter sometimes referred to as merely a “separator”) in accordance with an embodiment of the present invention is a porous film that is filmy and is provided between a cathode and an anode of a nonaqueous electrolyte secondary battery.

The porous film is not limited to a specific one, provided that it is made of a porous and filmy base material containing a polyolefin resin as a major component (i.e., made of a polyolefin porous base material). That is, the porous film is a film that (i) has therein pores connected to one another and (ii) allows a gas or a liquid to pass therethrough from one surface to the other surface.

In a case where the separator generates heat, the porous film is melted, so as to make the separator nonporous. This causes the separator to have a shutdown function.

The porous film has a thickness of 20 μm or less, preferably 4 μm to 20 μm, more preferably 6 μm to 16 μm, and still more preferably 9 μm to 16 μm.

The porous film has a volume-based porosity of 20% by volume to 55% by volume, and more preferably 40% by volume to 55% by volume so as to allow the nonaqueous secondary battery separator to (i) retain a larger amount of electrolyte solution and (ii) achieve a function of reliably preventing (shutting down) a flow of an excessively large current at a lower temperature.

The porous film is cut to have a certain size when it is incorporated as a separator in a nonaqueous electrolyte secondary battery. In a case where the porous film is, for example, torn in an unintended direction during cutting, a reduction occurs in yields of manufactured lithium secondary batteries. Cutting processibility is demanded for, in especial, the porous film having the above thickness and porosity.

The inventor of the present invention made a diligent study and first found that (i) a minimum height from which a ball, with a diameter of 14.3 mm and a weight of 11.9 g, is made to free-fall on a porous film, so that the porous film is caused to be torn and (ii) cutting processibility correlate each other. Specifically, in a case where the minimum height is not less than 50 cm, it is possible to withhold the porous film from being torn in an unintended direction. The inventor has thus accomplished the present invention. Note that the minimum height is preferably less than 150 cm. This is because it is necessary for the porous film to be thicker or to have a lower porosity in order for the minimum height to be more than 150 cm while balancing molecular orientations (i) in a machine direction (MD) and (ii) in a transverse direction (TD). However, an increase in thickness of the porous film causes a reduction in energy density of a battery, whereas a decrease in porosity of the porous film causes a battery characteristic (particularly, rate characteristic) to become unsatisfactory.

The porous film is obtained through a rolling step (later described). During the rolling step, a brittle skin layer is formed on a surface of the porous film. Furthermore, a difference occurs between molecular orientations of the MD and TD, depending on conditions of the rolling step. A difference also occurs between molecular orientations of the MD and TD, depending on drawing conditions. Only drawing in the TD causes the molecules of the porous film oriented in the TD to be dominant, whereas only drawing in the MD causes the molecules of the porous film oriented in the MD to be dominant. Thus, (i) a proportion of a skin layer in the entire porous film and (ii) a molecular orientation between the MD and TD are related to how the porous film is torn. Specifically, the porous film becomes weaker against shocks and is more easily torn in an unintended direction, as the proportion of the brittle skin layer increases. Furthermore, in a case where the molecules oriented in the MD or the TD are dominant, the porous film is easily torn in a direction in which the molecules are dominantly oriented. As such, the proportion of the skin layer and the molecular orientation between the MD and TD affects cutting processibility of the porous film.

The inventor of the present invention found that (i) tearing easiness, which depends on the proportion of the skin layer and the molecular orientation between the MD and TD and (ii) a minimum height from which a ball, with a diameter of 14.3 mm and a weight of 11.9 g, is made to free-fall on a porous film, so that the porous film is caused to be torn, correlate each other. That is, (i) the proportion of the skin layer and (ii) a difference between molecular orientations of the MD and TD decrease as the minimum height increases. As described later in Examples, in a case where the minimum height is not less than 50 cm, it is possible to withhold the porous film from being torn in an unintended direction during cutting process of the porous film, so that the cutting processability of the porous film is improved.

In a case where the molecules oriented in the MD or the TD are dominant, a greater friction occurs in a direction orthogonal to a direction in which the molecules are dominantly oriented. That is, the molecular orientation between the MD and TD affects a friction that occurs in a case where the porous film comes into contact with other components in a battery. The inventor of the present invention found that in a case of a porous film with regard to which a minimum height is not less than 50 cm from which a ball, with a diameter of 14.3 mm and a weight of 11.9 g, is made to free-fall on the porous film, so that the porous film is caused to be torn, the molecular orientation between the MD and TD is balanced to such a degree that a friction, that occurs in a case where the porous film comes into contact with other components in nonaqueous electrolyte secondary batteries, can be reduced. It is therefore possible to improve slip characteristics of a separator with respect to pins by, during assembly of a nonaqueous electrolyte secondary battery of winding-type, winding the separator and electrodes around a pin such that a surface of the porous film, whose minimum height is less than 50 cm, keeps being brought into contact with the pin. This allows the pin to be easily withdrawn from the separator, and ultimately allows a reduction in troubles occurred during a step of withdrawing the pin.

The porous film normally contains a polyolefin component at a proportion of 50% by volume or more relative to the entire porous film. Such a proportion of the polyolefin component is preferably 90% by volume or more, and more preferably 95% by volume or more.

Examples of the polyolefin-based resin constituting the porous film include high molecular weight homopolymers or copolymers produced through polymerization of ethylene, propylene, 1-butene, 4-methyl-1-pentene, 1-hexene, and/or the like. Among the examples, a high molecular weight polyethylene having an average-molecular weight of 1,000,000 or more and containing ethylene as a main component is preferable. Note that the porous film can contain another component which is not a polyolefin, insofar as the another component does not impair the function of the layer.

In view of production cost and physical properties, a porous film that contains a polyolefin resin as a main component is preferably produced by for example the method below on the assumption that the porous film is formed from a polyolefin resin containing ultrahigh-molecular-weight polyethylene and low molecular weight polyolefin having a weight-average molecular weight of not more than 10,000.

That is, the porous film can be obtained by the method including the steps of: (1) kneading the ultrahigh-molecular-weight polyethylene, the low-molecular-weight polyolefin having a weight-average molecular weight of not more than 10,000, and a pore forming agent such as calcium carbonate or a plasticizing agent to obtain a polyolefin resin composition, (2) rolling the polyolefin resin composition by using pressure rolls to form a sheet (rolling step), (3) removing the pore forming agent from the sheet obtained in the step (2), and (4) drawing the sheet obtained in the step (3).

A skin layer that is formed during the step (2) can be reduced by thickening, in the step (2), the sheet to have a thickness larger than those of conventional porous films. This allows (i) the step (2) to be finished quickly and (ii) molecules of the porous film to be moderately oriented in the MD. This allows the molecules of the porous film to be evenly oriented in the MD and TD. It is therefore possible to produce a porous film with regard to which a minimum height is not less than 50 cm from which a ball, with a diameter of 14.3 mm and a weight of 11.9 g, is made to free-fall on the porous film, so that the porous film is caused to be torn.

[2. Nonaqueous Electrolyte Secondary Battery]

A nonaqueous electrolyte secondary battery in accordance with an embodiment of the present invention includes the separator described above. More specifically, the nonaqueous electrolyte secondary battery of the present embodiment includes a nonaqueous electrolyte secondary battery member in which a cathode, a separator, and an anode are arranged in this order. That is, the nonaqueous electrolyte secondary battery member is also encompassed within the scope of the present invention.

The nonaqueous electrolyte secondary battery is configured so that a battery clement is sealed into an external packaging member. The battery element is configured so that a structure is impregnated with an electrolyte solution. The structure is configured so that an anode sheet and a cathode sheet face each other via the nonaqueous electrolyte secondary battery separator described above. The nonaqueous electrolyte secondary battery, which is produced by using the nonaqueous electrolyte secondary battery separator in accordance with an embodiment of the present invention, achieves a high production yield. This is because (i) a cutting blade of a separator cutting machine needs to be replaced less frequently and (ii) a pin is easily withdrawn.

The description below will deal with a lithium ion secondary battery as an example of the nonaqueous electrolyte secondary battery. Note that components of the nonaqueous electrolyte secondary battery, other than the separator, are not limited to those described below.

The nonaqueous electrolyte secondary battery in accordance with an embodiment of the present invention can use, for example, a nonaqueous electrolyte solution prepared by dissolving a lithium salt in an organic solvent. Examples of the lithium salt include LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, and LiAlCl₄. Embodiment 1 may use only one kind of the above lithium salts or two or more kinds of the above lithium salts in combination.

It is preferable to use, out of the above lithium salts, at least one fluorine-containing lithium salt selected from the group consisting of LiPF₆, LiAsF₆, LiSbF₆, LiBF₄, LiCF₃SO₃, LiN(CF₃SO₂)₂, and LiC(CF₃SO₂)₃.

Specific examples of the organic solvent in the nonaqueous electrolyte solution include carbonates such as ethylene carbonate, propylene carbonate, dimethyl carbonate, diethyl carbonate, ethyl methyl carbonate, 4-trifluoromethyl-1,3-dioxolane-2-on, and 1,2-di(methoxy carbonyloxy)ethane; ethers such as 1,2-dimethoxyethane, 1,3-dimethoxypropane, pentafluoropropyl methylether, 2,2,3,3-tetrafluoropropyl difluoro methylether, tetrahydrofuran, and 2-methyl tetrahydrofuran; esters such as methyl formate, methyl acetate, and γ-butyrolaclone; nitrites such as acetonitrile and butyronitrile; amides such as N,N-dimethylformamide and N,N-dimethylacetamide; carbamates such as 3-methyl-2-oxazolidone; sulfur-containing compounds such as sulfolane, dimethyl sulfoxide, and 1,3-propane sultone; and fluorine-containing organic solvents each prepared by introducing a fluorine group into the organic solvents described above. It is possible to use only one kind of the above organic solvents or two or more kinds of the above organic solvents in combination.

Out of the above organic solvents, it is preferable to use carbonates. It is more preferable to use (i) a mixed solvent of a cyclic carbonate and an acyclic carbonate or (ii) a mixed solvent of a cyclic carbonate and an ether is more preferable.

It is more preferable to use, as the mixed solvent of a cyclic carbonate and an acyclic carbonate, a mixed solvent containing ethylene carbonate, dimethyl carbonate, and ethyl methyl carbonate. This is because such a mixed solvent (i) has a wider operating temperature range and (ii) is not easily decomposed even in a case where a graphite material, such as natural graphite or artificial graphite, is used as an anode active material.

The cathode is normally a sheet-shaped cathode including (i) a cathode mix containing a cathode active material, a conductive material, and a binding agent and (ii) a cathode current collector supporting the cathode mix thereon.

The cathode active material is, for example, a material capable of being doped and dedoped with lithium ions. Specific examples of such a material include a lithium complex oxide containing at least one transition metal such as V, Mn, Fe, Co, or Ni.

Among such lithium complex oxides, (i) a lithium complex oxide having an α-NaFeO₂ structure such as lithium nickelate and lithium cobaltate and (ii) a lithium complex oxide having a spinel structure such as lithium manganese spinel are preferable because such lithium complex oxides have a high average discharge potential. The lithium complex oxide may further contain any of various metallic elements, and is more preferably complex lithium nickelate.

Further, the complex lithium nickelate particularly preferably contains at least one metallic element selected from the group consisting of Ti, Zr, Ce, Y, V, Cr, Mn, Fe, Co, Cu, Ag, Mg, Al, Ga, In, and Sn at a proportion of 0.1 mol % to 20 mol % with respect to the sum of the number of moles of the at least one metallic element and the number of moles of Ni in the lithium nickelate. This is because such a complex lithium nickelate allows an excellent cycle characteristic for use in a high-capacity battery. Among such complex lithium nickelate, an active material which contains Al or Mn and in which a ratio of Ni is 85% or more, and more preferably 90% or more is particularly preferable. This is because such an active material allows an excellent cycle characteristic for use in a high-capacity nonaqueous electrolyte secondary battery including a cathode containing the active material.

Examples of the conductive material include carbonaceous materials such as natural graphite, artificial graphite, cokes, carbon black, pyrolytic carbons, carbon fiber, and a fired product of an organic polymer compound. Embodiment 1 may use (i) only one kind of the above conductive materials or (ii) two or more kinds of the above conductive materials in combination, for example a mixture of artificial graphite and carbon black.

Examples of the binding agent include polyvinylidene fluoride, a vinylidene fluoride copolymer, polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, an ethylene-tetrafluoroethylene copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and thermoplastic resins such as thermoplastic polyimide, polyethylene, and polypropylene. Acrylic resin and styrene butadiene rubber can also be used. Note that the binding agent also functions as a thickener.

The cathode mix may be prepared by, for example, a method of applying pressure to the cathode active material, the conductive material, and the binding agent on the cathode current collector or a method of using an appropriate organic solvent so that the cathode active material, the conductive material, and the binding agent are in a paste form.

The cathode current collector is, for example, an electric conductor such as Al, Ni, and stainless steel, among which Al is preferable because Al is easily processed into a thin film and is inexpensive.

The sheet-shaped cathode may be produced, that is, the cathode mix may be supported by the cathode current collector, through, for example, a method of applying pressure to the cathode active material, the conductive material, and the binding agent on the cathode current collector to form a cathode mix thereon or a method of (i) using an appropriate organic solvent so that the cathode active material, the conductive material, and the binding agent are in a paste form to provide a cathode mix, (ii) applying the cathode mix to the cathode current collector, (iii) drying the applied cathode mix to prepare a sheet-shaped cathode mix, and (iv) applying pressure to the sheet-shaped cathode mix so that the sheet-shaped cathode mix is firmly fixed to the cathode current collector.

The anode is normally a sheet-shaped anode including (i) an anode mix containing an anode active material and (ii) an anode current collector supporting the anode mix thereon. The sheet-shaped anode can include the conductive material and/or the binding agent.

The anode active material is, for example, (i) a material capable of being doped and dedoped with lithium ions, (ii) a lithium metal, or (iii) a lithium alloy. Specific examples of the material include carbonaceous materials such as natural graphite, artificial graphite, cokes, carbon black, pyrolytic carbons, carbon fiber, and a fired product of an organic polymer compound; chalcogen compounds such as an oxide and a sulfide that are doped and dedoped with lithium ions at an electric potential lower than that for the cathode; metal such as aluminum (Al), lead (Pb), tin (Sn), bismuth (Bi), or silicon (Si) which is alloyed with alkali metal; an intermetallic compound (AlSb, Mg₂Si, NiSi₂) of a cubic system in which intermetallic compound alkali metal can be inserted in voids in a lattice; and a lithium nitrogen compound (Li₃₋ₓMₓN (M: transition metal)). Among the above anode active materials, a carbonaceous material containing a graphite material such as natural graphite or artificial graphite as a main component is preferable, an anode active material which is a mixture of graphite and silicon and in which mixture a ratio of Si to C is 5% or more is more preferable, and an anode active material in which a ratio of Si to C is 10% or more is further preferable. This is because such a carbonaceous material has high electric potential flatness and low average discharge potential and can thus be combined with a cathode to achieve high energy density.

The anode mix may be prepared by, for example, a method of applying pressure to the anode active material an the anode current collector or a method of using an appropriate organic solvent so that the anode active material is in a paste form.

The anode current collector is, for example, Cu, Ni, or stainless steel, among which Cu is preferable because Cu is not easily alloyed with lithium in the case of a lithium ion secondary battery and is easily processed into a thin film.

The sheet-shaped anode may be produced, that is, the anode mix may be supported by the anode current collector, through, for example, a method of applying pressure to the anode active material on the anode current collector to form an anode mix thereon or a method of (i) using an appropriate organic solvent so that the anode active material is in a paste form to provide an anode mix, (ii) applying the anode mix to the anode current collector, (iii) drying the applied anode mix to prepare a sheet-shaped anode mix, and (iv) applying pressure to the sheet-shaped anode mix so that the sheet-shaped anode mix is firmly fixed to the anode current collector. The above paste can include a conductive aid and/or the binding agent.

The nonaqueous electrolyte secondary battery in accordance with an embodiment of the present invention may be produced by (i) arranging the cathode, the separator, and the anode in this order so as to form a nonaqueous electrolyte secondary battery member, (ii) inserting the nonaqueous electrolyte secondary battery member into a container for use as a housing of the nonaqueous electrolyte secondary battery, (iii) filling the container with a nonaqueous electrolyte solution, and (iv) hermetically sealing the container under reduced pressure. The nonaqueous electrolyte secondary battery may have any shape such as the shape of a thin plate (paper), a disk, a cylinder, or a prism such as a cuboid. The nonaqueous electrolyte secondary battery may be produced through any method, and may be produced through a conventionally publicly known method.

### Embodiment 2

Embodiment 1 has discussed a configuration in which a nonaqueous electrolyte secondary battery separator (i.e., porous film) is employed as a separator in a nonaqueous electrolyte secondary battery. However, a separator in accordance with an embodiment of the present invention can be a nonaqueous electrolyte secondary battery laminated separator (hereinafter sometimes referred to as a “laminated separator”) including (i) the nonaqueous electrolyte secondary battery separator, which is a porous film in accordance with Embodiment 1 of the present invention and (ii) a publicly-known porous layer(s) such as an adhesive layer, a heat-resistant layer, and/or a protective layer.

A porous film used in Embodiment 2 is the same as that discussed in Embodiment 1. Thus, Embodiment 2 discusses only the porous layer. Note that (i) a thickness, (ii) a porosity, and (iii) a minimum height from which a ball is made to free-fall on the porous film, so that the porous film is caused to be torn can be measured with respect to any one of (a) a porous film to which the porous layer has not been laminated yet and (b) a porous film that is obtained by removing the porous layer from the nonaqueous electrolyte secondary battery laminated separator.

The porous layer is laminated on one surface of the nonaqueous electrolyte secondary battery separator (i.e., porous film). The porous layer is preferably laminated on a surface of the porous film which surface faces the cathode, more preferably on a surface of the porous film which surface comes into contact with the cathode, when the porous film is incorporated into the nonaqueous electrolyte secondary battery.

The porous layer is preferably a resin-containing layer. A resin which constitutes such a porous layer is made is preferably (i) insoluble in the electrolyte solution contained in the nonaqueous electrolyte secondary battery and (ii) electrochemically stable in a range where the nonaqueous electrolyte secondary battery is used.

Examples of the resin of which the porous layer is made include: polyolefins such as polyethylene, polypropylene, polybutene, and an ethylene-propylene copolymer; fluorine-containing resins such as polyvinylidene fluoride (PVDF) and polytetrafluoroethylene; fluorine-containing rubbers such as a vinylidene fluoride-hexafluoropropylene copolymer, a tetrafluoroethylene-hexafluoropropylene copolymer, a tetrafluoroethylene-perfluoroalkyl vinyl ether copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer; aromatic polyamide; wholly aromatic polyamide (aramid resin); rubbers such as a styrene-butadiene copolymer and a hydride thereof, a methacrylate ester copolymer, an acrylonitrile-acrylic ester copolymer, a styrene-acrylic ester copolymer, ethylene propylene rubber, and polyvinyl acetate; resins having a melting point or a glass transition temperature of not less than 180° C., such as polyphenylene ether, polysulfone, polyether sulfone, polyphenylene sulfide, polyetherimide, polyamide-imide, polyether amide, and polyester; water-soluble polymers such as polyvinyl alcohol, polyethylene glycol, cellulose ether, sodium alginate, polyacrylic acid, polyacrylamide, and polymethacrylic acid; and the like.

Specific examples of the aromatic polyamides include poly(paraphenylene terephthalamide), poly(methaphenylene isophthalamide), poly(parabenzamide), poly(methabenzamide), poly(4,4′-benzanilide terephthalamide), poly(paraphenylene-4,4′-biphenylene dicarboxylic acid amide), poly(methaphenylene-4,4′-biphenylene dicarboxylic acid amide), poly(paraphenylene-2,6-naphthalene dicarboxylic acid amide), poly(methaphenylene-2,6-naphthalene dicarboxylic acid amide), poly(2-chloroparaphenylene terephthalamide), paraphenylene terephthalamide/2,6-dichloroparaphenylene terephthalamide copolymer, and methaphenylene terephthalamide/2,6-dichloroparaphenylene terephthalamide copolymer. Among these, poly(paraphenylene terephthalamide) is preferable.

Among the above resins, a polyolefin, a fluorine-containing resin, an aromatic polyamide, and a water-soluble polymer are more preferable, and a fluorine-containing resin is particularly preferable. Use of a fluorine-containing resin makes it easy to maintain various performance capabilities such as a rate characteristic and a resistance characteristic (solution resistance) of the nonaqueous electrolyte secondary battery even in a case where a deterioration in acidity occurs while the nonaqueous electrolyte secondary battery is being operated. A water-soluble polymer, which allows water to be used as a solvent to form the porous layer, is more preferable in terms of a process or an environmental load, cellulose ether and sodium alginate are further preferable, and cellulose ether is particularly preferable.

Specific examples of the cellulose ether include carboxymethyl cellulose (CMC), hydroxyethyl cellulose (HEC), carboxy ethyl cellulose, methyl cellulose, ethyl cellulose, cyan ethyl cellulose, and oxyethyl cellulose. Among these, CMC and HEC, which less deteriorate after being used for a long time and have excellent chemical stability, are more preferable, and CMC is particularly preferable.

The porous layer more preferably contains a filler. In a case where the porous layer contains a filler, the resin functions as a binder resin. The filler is not particularly limited to a specific one and can be a filler made of organic matter or a filler made of inorganic matter.

Specific examples of the filler made of organic matter include fillers made of (i) a homopolymer of a monomer such as styrene, vinyl ketone, acrylonitrile, methyl methacrylate, ethyl methacrylate, glycidyl methacrylate, glycidyl acrylate, or methyl acrylate, or (ii) a copolymer of two or more of such monomers; fluorine-containing resins such as polytetrafluoroethylene, a tetrafluoroethylene-hexafluoropropylene copolymer, a tetrafluoroethylene-ethylene copolymer, and polyvinylidene fluoride; melamine resin; urea resin; polyethylene; polypropylene; and polyacrylic acid and polymethacrylic acid.

Specific examples of the filler made of inorganic matter include fillers made of calcium carbonate, talc, clay, kaolin, silica, hydrotalcite, diatomaceous earth, magnesium carbonate, barium carbonate, calcium sulfate, magnesium sulfate, barium sulfate, aluminum hydroxide, boehmite, magnesium hydroxide, calcium oxide, magnesium oxide, titanium oxide, titanium nitride, alumina (aluminum oxide), aluminum nitride, mica, zeolite, or glass. The porous layer may contain (i) only one kind of filler or (ii) two or more kinds of fillers in combination.

Among the above fillers, a filler made of inorganic matter is suitable. A filler made of an inorganic oxide such as silica, calcium oxide, magnesium oxide, titanium oxide, alumina, mica, zeolite, aluminum hydroxide, or boehmite is more preferable. A filler made of at least one kind selected from the group consisting of silica, magnesium oxide, titanium oxide, aluminum hydroxide, boehmite, and alumina is further preferable. A filler made of alumina is particularly preferable. While alumina has many crystal forms such as α-alumina, β-alumina, γ-alumina, and θ-alumina, any of the crystal forms can be used suitably. Among the above crystal forms, α-alumina is the most preferable because it is particularly high in thermal stability and chemical stability.

The filler has a shape that varies depending on, for example, (i) the method of producing the organic matter or inorganic matter as a raw material and (ii) the condition under which the filler is dispersed when the coating solution for forming a porous layer is prepared. The filler may have any shape such as a spherical shape, an oblong shape, a rectangular shape, a gourd shape, or an indefinite, irregular shape.

In a case where the porous layer contains a filler, the filler is contained in an amount of preferably 1% by volume to 99% by volume, and more preferably 5% by volume to 95% by volume, with respect to the porous layer. The porous layer containing the filler in an amount falling within the above range makes it less likely for a void, which is formed when fillers make contact with each other, to be blocked by a resin or the like. This makes it possible to achieve sufficient ion permeability and an appropriate weight per unit area of the porous layer.

According to an embodiment of the present invention, a coating solution for forming a porous layer is normally prepared by dissolving the resin in a solvent and further dispersing the above filler in the solvent.

The solvent (disperse medium) may be any solvent that does not adversely influence the porous film, that allows the resin to be dissolved uniformly and stably, and that allows the filler to be dispersed uniformly and stably. Specific examples of the solvent (disperse medium) include water; lower alcohols such as methyl alcohol, ethyl alcohol, n-propyl alcohol, isopropyl alcohol, and t-butyl alcohol; acetone, toluene, xylene, hexane, N-methylpyrrolidone, N,N-dimethylacetamide, and N,N-dimethylformamide. Embodiment 2 may use only one kind of solvent (disperse medium) or two or more kinds of solvents in combination.

The coating solution may be formed by any method, provided that the coating solution meets conditions (such as a resin solid content (resin concentration) and an amount of fillers) which are necessary for obtaining a desired porous layer. Specific examples of a method of forming the coating solution include a mechanical stirring method, an ultrasonic dispersion method, a high-pressure dispersion method, and a media dispersion method.

The filler can be dispersed in the solvent (disperse medium) by the use of a conventionally known dispersing device such as a three-one motor, a homogenizer, a medium type dispersing device, or a pressure type dispersing device. Further, a liquid in which the resin is dissolved or swollen or an emulsified liquid of the resin can be supplied to a wet grinding device when a filler is wet ground in order to obtain a tiller having an intended average particle diameter, and it is thus possible to prepare a coating liquid concurrently with the wet grinding of the filler. That is, the wet grinding of the filler and the preparation of the coating liquid can be carried out in a single process.

The coating solution can contain, as a component other than the resin and the filler, an additive such as a dispersing agent, a plasticizing agent, a surfactant, or a pH adjusting agent, provided that such an additive does not impair the object of the present invention. Note that the additive can be added in an amount that does not impair the object of the present invention.

There is no particular limit to how the coating solution is applied to the separator, that is, how a porous layer is formed on a surface of a separator that has been subjected to a hydrophilization treatment as necessary.

Examples of a method of forming a porous layer include: a method in which the coating solution is directly applied to a surface of the separator and then a solvent (disperse medium) is removed; a method in which a porous layer is formed by applying the coating solution to an appropriate support and removing the solvent (disperse medium), and then the porous layer thus formed is pressure-bonded to the separator, and subsequently the support is peeled off; a method in which the coating solution is applied to an appropriate support and the porous film is pressure-bonded to an application surface, and subsequently the support is peeled off and then the solvent (disperse medium) is removed; and a method in which the separator is immersed in the coating solution so as to carry out dip coating, and then the solvent (disperse medium) is removed.

The thickness of the porous layer may be controlled by adjusting, for example, (i) the thickness of a coating film in a wet state after the coating, (ii) the weight ratio of the resin and fine particles, and/or (iii) the solid content concentration of the coating solution (that is, the sum of the resin concentration and fine-particle concentration). Note that, for example, the support can be a film made of resin, a belt made of metal, a drum, or the like.

The coating solution is applied to the separator or the support through any method that allows the coating solution to be applied in a necessary weight per unit area with a necessary coating area. The coating solution may be applied through a conventionally publicly known method. Specific examples of the method include gravure coater method, small-diameter gravure coater method, reverse roll coater method, transfer roll coater method, kiss coater method, dip coater method, knife coater method, air doctor blade coater method, blade coater method, rod coater method, squeeze coater method, cast coater method, bar coater method, die coater method, screen printing method, and spray applying method.

The solvent (disperse medium) is typically removed by a drying method. Examples of the drying method include natural drying, air-blow drying, heat drying, and vacuum drying. Note, however, that any drying method can be used, provided that the solvent (disperse medium) can be sufficiently removed by such a drying method. The above drying can be carried out by use of a normal drying device.

The drying can be carried out after substituting the solvent (disperse medium) contained in the coating solution with another solvent. Examples of a method of substituting the solvent (disperse medium) with another solvent and then removing the another solvent include a method in which (i) another solvent (hereinafter, referred to as “solvent X”) is dissolved in the solvent (disperse medium) contained in the coating solution and does not dissolve a resin contained in the coating solution, (ii) the separator or the support on which a coating film has been formed by applying the coating solution is immersed in the solvent X, (iii) the solvent (disperse medium) contained in the coating film on the separator or the support is substituted with the solvent X, and then (iv) the solvent X is evaporated. Such a method makes it possible to efficiently remove the solvent (disperse medium) from the coating solution.

In a case where heating is carried out in order to remove the solvent (disperse medium) or the solvent X from the coating film of the coating solution which coating film has been formed on the separator or the support, it is desirable to carry out the heating at a temperature at which the air permeability of the separator is not decreased, specifically 10° C. to 120° C. and more preferably 20° C. to 80° C., in order to prevent the air permeability of the porous film from decreasing due to contraction of the pores of the porous film.

Preferably, the porous layer formed by the above method has a thickness of 0.5 μm to 15 μm, and more preferably of 2 μm to 10 μm.

In a case where (i) the porous layer has a thickness of less than 0.5 μm and (ii) the laminated separator is used in a nonaqueous electrolyte secondary battery, it is impossible to sufficiently prevent an internal short circuit caused by, for example, a breakage of the nonaqueous electrolyte secondary battery. Moreover, such a case causes a decrease in amount of electrolyte solution retained by the porous layer.

Meanwhile, in a case where (i) the porous film has a thickness of more than 15 μm and (ii) the laminated separator is used in the nonaqueous electrolyte secondary battery, a resistance against permeation of lithium ions increases in an entire area of the separator. In a case where a cycle is repeated, therefore, the cathode of the nonaqueous electrolyte secondary battery deteriorates, and this causes a deterioration in rate characteristic and/or cycle characteristic. Further, a distance between the cathode and the anode increases, and this causes the nonaqueous electrolyte secondary battery to be larger in size.

The porous layer only needs to have a weight per unit area which is determined as appropriate in view of strength, thickness, weight, and handling easiness of the laminated separator. The weight per unit area of the porous layer is normally preferably 1 g/m² to 20 g/m², and more preferably 2 g/m² to 10 g/m² in a case where the laminated separator is used in a nonaqueous electrolyte secondary battery.

In a case where the porous layer has a weight per unit area which falls within such a numerical range, it is possible to increase the weight energy density and volume energy density of a nonaqueous electrolyte secondary battery including the porous layer. In a case where the weight per unit area of the porous layer exceeds the above numerical range, a nonaqueous electrolyte secondary battery including the laminated separator will be heavy.

The porous layer has a porosity of preferably 20% by volume to 90% by volume, and more preferably 30% by volume to 80% by volume, in order to achieve sufficient ion permeability. The pore diameter of pores in the porous layer is preferably not more than 1 μm, and more preferably not more than 0.5 μm. In a case where the pores have such a pore diameter, a nonaqueous electrolyte secondary battery including a laminated separator including the porous layer can achieve sufficient ion permeability.

The laminated separator has preferably an air permeability of 30 sec/100 mL to 1000 sec/100 mL, and more preferably an air permeability of 50 sec/100 mL to 800 sec/100 mL, in terms of Gurley values. A laminated separator having such an air permeability achieves sufficient ion permeability in a case where the laminated separator is used as a member of the nonaqueous electrolyte secondary battery.

An air permeability larger than the above range means that the laminated separator has a high porosity and thus has a coarse laminated structure. This may result in the Laminated separator having decreased strength, in particular insufficient shape stability at high temperatures. An air permeability smaller than the above range, on the other hand, may prevent the laminated separator from having sufficient ion permeability when used as a member of the nonaqueous electrolyte secondary battery and thus degrade the battery characteristics of the nonaqueous electrolyte secondary battery.

Embodiment 2 can be incorporated into a nonaqueous electrolyte secondary battery as with Embodiment 1, provided that the nonaqueous electrolyte secondary battery separator (separator) used in Embodiment 1 is replaced with the nonaqueous electrolyte secondary battery laminated separator in accordance with Embodiment 2. During assembly of nonaqueous electrolyte secondary battery of winding-type, the nonaqueous electrolyte secondary battery laminated separator and electrodes are wound around a pin such that a surface of the porous film keeps being brought into contact with the pin. As described earlier, in a case of a porous film with regard to which a minimum height is not less than 50 cm from which a ball, with a diameter of 14.3 mm and a weight of 11.9 g, is made to free-fall on the porous film, so that the porous film is caused to be torn, the molecular orientation between the MD and TD is balanced to such a degree that a friction, that occurs in a case where the porous film comes into contact with other components in nonaqueous electrolyte secondary batteries, can be reduced. This improves slip characteristics of the separator with respect to pins, and ultimately allows a reduction in troubles occurred during a step of withdrawing the pin.

### Embodiment 3

Embodiment 2 has discussed a configuration in which a minimum height from which a ball is made to free-fall on the porous film, so that the porous film is caused to be torn, is not less than 50 cm.

However, the present invention is not limited to such a porous film. The scope of the present invention also cover a nonaqueous electrolyte secondary battery laminated separator with regard to which a minimum height is not less than 50 cm from which a ball, with a diameter of 14.3 mm and a weight of 11.9 g, is made to free-fall on the nonaqueous electrolyte secondary battery laminated separator, so that the nonaqueous electrolyte secondary battery laminated separator is caused to be torn. That is, the porous film does not necessarily meet the requirement that a minimum height is not less than 50 cm from which a ball, with a diameter of 14.3 mm and a weight of 11.9 g, is made to free-fall on the porous film, so that the porous film is caused to be torn, provided that the nonaqueous electrolyte secondary battery laminated separator meets a requirement that a minimum height is not less than 50 cm from which a ball, with a diameter of 14.3 mm and a weight of 11.9 g, is made to free-fall on the nonaqueous electrolyte secondary battery laminated separator, so that the nonaqueous electrolyte secondary battery laminated separator is caused to be torn.

According to the nonaqueous electrolyte secondary battery laminated separator in accordance with Embodiment 3, (i) the ratio of the skin layer and (ii) the balance of molecular orientation between MD and TD also bring about a state suitable for (a) cutting processibility of and (b) slip characteristics, with respect to pins, of the nonaqueous electrolyte secondary battery laminated separator. This allows improvements in the above (a) and (b).

### EXAMPLES

The following description will more specifically discuss the present invention with reference to Examples, to which the present invention is never be limited.

<Method of Measuring Various Physical Properties>

Various physical properties of porous films (nonaqueous electrolyte secondary battery separators) and nonaqueous electrolyte secondary battery laminated separators in accordance with respective Examples and Comparative Examples were measured as below.

(1) Thickness

A thickness D (μm) of each porous film was measured in conformity to the Japanese Industrial Standard (JIS K7130-1992).

(2) Porosity

A 10-cm square is cut out from each porous film, and its weight W (g) was then measured. Then, a porosity (% by volume) of the 10-cm square thus cut out was calculated by using the thickness D (μm) and the weight W (g), based on the following expression:

Porosity (% by weight)=(1−(W/Specific gravity)/(10×10×D/10000))×100

(3) Falling-Ball Test

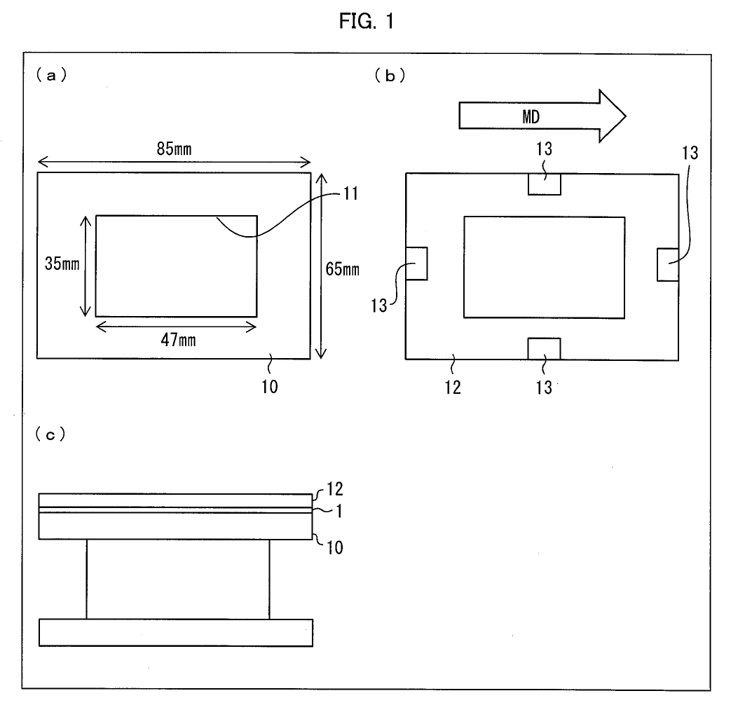

FIG. 1 illustrates a jig used in the falling-ball test, (a) of FIG. 1 is a top view of a frame 10 on which a measuring sample (porous film or nonaqueous electrolyte secondary battery laminated separator) 1 is placed. As illustrated in (a) of FIG. 1, the frame 10 has a rectangular outer shape of 85 mm×65 mm and has a hole 11 of 47 mm×35 mm. The measuring sample 1, which has been cut so as to have size of 85 mm×65 mm, is placed on the frame 10 such that the MD of the measuring sample 1 is parallel to long sides of the hole 11. As illustrated in (b) of FIG. 1, a stainless steel plate 12, which has a rectangular shape identical to that of the frame 10, is placed on the measuring sample 1, and then the frame 10 and the stainless steel plate 12 are fixed, at or near the center of each side, by using clamps (non-twist clamps) 13 so that the measuring sample 1 does not slip. (c) of FIG. 1 is a lateral view of the measuring sample 1 fixed to the jig. As illustrated in (c) of FIG. 1, the measuring sample 1 is sandwiched between the frame 10 and the stainless steel plate 12.

The falling-ball test is carried out more than once. In the falling-ball test, (i) a ball, with a diameter of 14.3 mm and a weight of 11.9 g, is made to free-fall on a measuring sample from above the hole while fixing the measuring sample to the jig (see (c) of FIG. 1) and (ii) whether or not the measuring sample is caused to be broken (torn) is confirmed. Note that a new measuring sample is used for each falling-ball test.

In the first falling-ball test, a height h₁ from which the ball is made to free-fall on the measuring sample is set in advance. The height h₁ can be set by, for example, (i) carrying out a preliminary test so that a height, at which a first measuring sample is likely to be broken, is determined and then (ii) setting the height h₁ to such a height. If the first measuring sample is broken as a result of the first falling-ball test, then a height h₂, from which the ball is made to free-fall on a second measuring sample, is set to (h₁−5 cm). If the second measuring sample is not broken as a result of the second falling-ball test, then the height h₂ is set to (h₁+5 cm). The falling-ball test is repeated by changing each height from which the ball is made lo free-fall on a corresponding measuring sample. That is, if a k-th measuring sample is broken as a result of a k-th falling-ball test (where k is an integer of 1 or more), then a height hₖ₊₁, from which the ball is made to free-fall on a (k+1)th measuring sample, is set to (hₖ−5 cm). If the (k+1)th measuring sample is not broken as a result of the kth falling-ball test (where k is an integer of 1 or more), then the height hₖ₊₁, from which the ball is made to free-fall on the (k+1)th measuring sample, is set to (hₖ+5 cm).

The falling-ball test was repeated, for each of Examples and Comparative Examples, until both of (i) the number of times of the falling-ball test in which a corresponding measuring sample was broken and (ii) the number of times of the falling-ball test in which a corresponding measuring sample was not broken reached five or more. A minimum height of the heights of the respective falling-ball tests in which the respective measuring samples were confirmed to have been broken was identified.

It would appear that “the minimum height from which a ball, with a diameter of 14.3 mm and a weight of 11.9 g, is made to free-fall on a porous film or a nonaqueous electrolyte secondary battery laminated separator, so that the porous film or the nonaqueous electrolyte secondary battery laminated separator is caused to be torn” depends on (i) energy of the ball which is made to free-fall and (ii) an area in which the ball and the measuring sample contact with each other. The energy of the ball which is made to free-fall can be identified based on a weight of the ball and a height from which the ball is made to free-fall. The superficial area, in which the ball which is made to free-fall and the measuring sample contact with each other, can be identified based on a diameter of the ball. That, is, how easily the measuring sample is apt to be torn can be sufficiently identified based on conditions of the falling-ball test. Note that the ball is a sphere whose center of mass is at the center thereof.

(4) Evaluation of Cutting Processibility

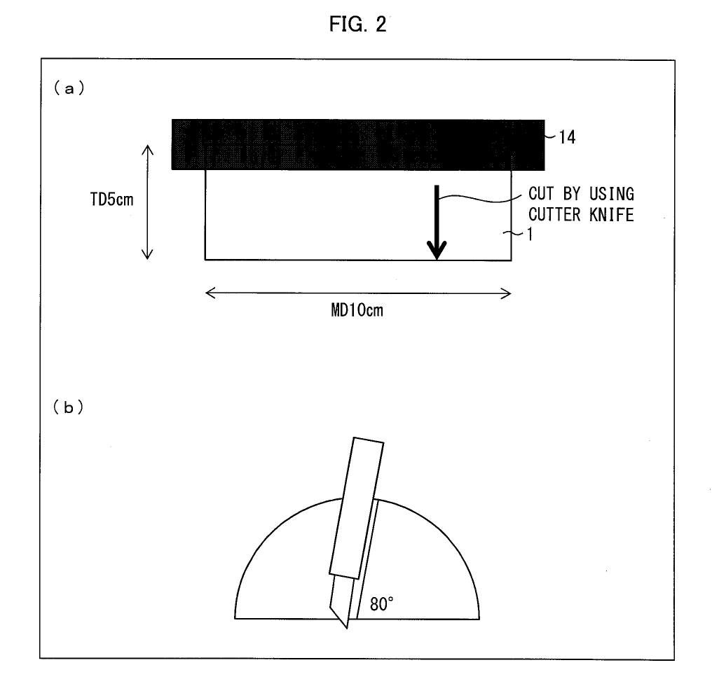

FIG. 2 illustrates how to evaluate cutting processibility. As illustrated in (a) of FIG. 2, one long side of the measuring sample (nonaqueous electrolyte secondary battery separator (porous film) or nonaqueous electrolyte secondary battery laminated separator) 1, obtained by cutting the measuring sample 1 so that the measuring sample 1 has a length of 10 cm in the MD and a length of 5 cm in the TD, was fixed by using a tape 14. As illustrated in (b) of FIG. 2, the measuring sample 1 thus fixed was cut by 3 cm in a direction parallel to The TD by using a cutter knife while the cutter knife was being kept at an angle of 80 degrees with respect to a horizontal direction. In so doing, the cutter knife was moved at a rate of approximately 8 cm/s. A cut state was then confirmed. Specifically, in a case where a cut place, that was confirmed to have been torn in an unintended direction (MD), was evaluated as “Bad,” whereas in a case where a cut place, that was confirmed to have not been torn, was evaluated as “Good”.

Note that a cutter knife manufactured by NT Inc. (Product No. A300) and a cutter platform manufactured by KOKUYO Co., Ltd. (Product No. Ma-44N) were used during the test, and the blade of the cutter knife was replaced, for each test, with a new replacement blade manufactured by NT Inc. (Product No. BA-160).

(5) Pin Pull-Out Test

The separators (nonaqueous electrolyte secondary battery separators or nonaqueous electrolyte secondary battery laminated separators) in accordance with respective Examples and Comparative Examples were each cut to have a strip of 62 mm in the TD and 30 cm in the MD. A weight of 300 g was attached to one end, in the MD, of the strip while the other end in the MD of the strip was five-turn wound around a stainless steel ruler (manufactured by Shinwa K.K., Product No. 13131) such that the TD of the separator was parallel to a longitudinal direction of the stainless steel ruler. Thereafter, the stainless steel ruler was pulled out at a rate of approximately 8 cm/s so that how the stainless steel ruler was apt to be pulled out (pull-out sensibility) was evaluated. Specifically, (i) in a case where the stainless steel ruler was smoothly pulled out without difficulty, the pull-out sensitivity was evaluated as “Good,” (ii) in a case where the stainless steel ruler was pulled out with slight difficulty, the pull-out sensitivity was evaluated as “Moderate,” and (iii) in a case where the stainless steel ruler was pulled out with difficulty, the pull-out sensitivity was evaluated as “Bad.” Note that the stainless steel ruler had a bent finger grip at one end in the longitudinal direction, and the stainless steel ruler was pulled out toward the bent finger grip.

Before and after the stainless steel ruler was pulled out, a width, in the TD, of the separator was measured, at a portion of the separator where the separator was five-turn wound around the stainless steel ruler, by using a Vernier caliper, so that a variation (mm) of the width was calculated. The variation indicates an amount by which the separator was extended in a direction in which the stainless steel ruler was pulled out when the separator was spirally changed in shape. The separator was spirally changed in response to the tongue of the five-turn winding of the separator having been moved, in the direction in which the stainless steel ruler is pulled out, by frictional force exerted between the stainless steel ruler and the separator.

(6) Pin Pull-Out Resistance

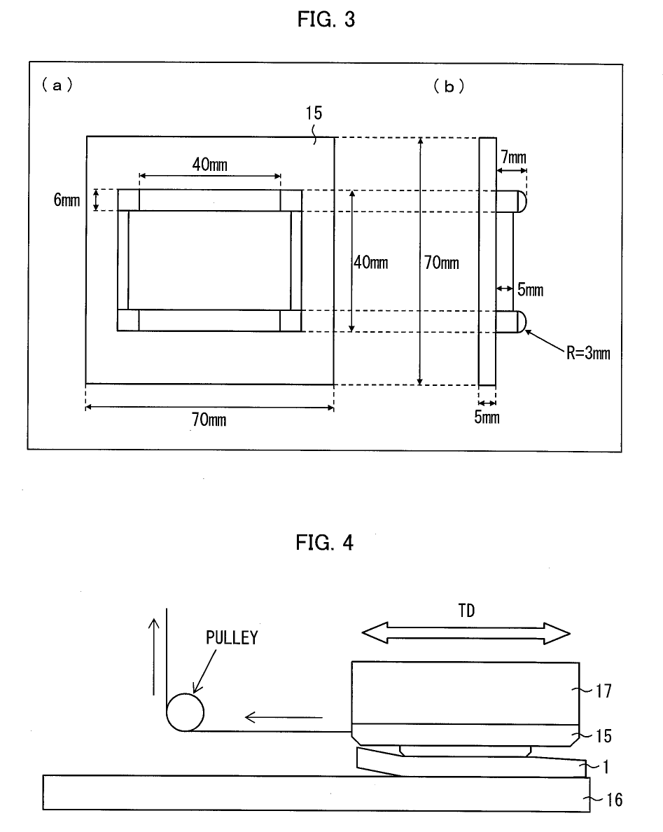

FIG. 3 illustrates a sleigh member for measuring a pin pull-out resistance, which indicates a strength of frictional force exerted between the surface of the separator and respective other components, (a) of FIG. 3 is a bottom view of the sleigh member, and (b) of FIG. 3 is a lateral view of the sleigh member. As illustrated in FIG. 3, two protrusions each having a tip whose curvature is 3 mm are provided on the bottom of the sleigh member 15. The two protrusions are provided so as to be away by 28 mm from each other and so as to be parallel to each other.

The separators (nonaqueous electrolyte secondary battery separators (porous films) or nonaqueous electrolyte secondary battery laminated separators) in accordance with respective Examples and Comparative Examples were each cut by 6 cm in the TD and 5 cm in the MD to prepare a measuring sample. Each measuring sample was attached to the sleigh member via a tape such that (i) the TD of the measuring sample matched a direction in which the two protrusions extended and (ii) the measuring sample was placed below the two protrusions. Note that a measuring sample, obtained from the nonaqueous electrolyte secondary battery laminated separators, was placed such that a porous layer thereof faced the sleigh member 15.

Subsequently, the sleigh member 15, to which the measuring sample 1 had been attached to the bottom, was placed on a plate coated with fluororesin (in this case, a plate 16 that had been coated with Silverstone® was used) (see FIG. 4). A weight 17 was then placed on the sleigh member 15 such that total weight of the weight 17 and the sleigh member 15 is equal to 1,800 g. The measuring sample 1 was arranged to be thus sandwiched between the plate 16 which had been coated with Silverstone and the sleigh member 15 (FIG. 4).

Note that Silverstone coating was carried out on a plate (high-speed tool steel SKH51) by Hakusui Co., Ltd. such that the coating had a thickness of 20 μm to 30 μm and a surface roughness Ra (measured by use of a HANDYSURF) of 0.8 μm.

The sleigh member 15 was then pulled at a rate of 20 mm/min by using AUTOGRAPH (Product No. AG-1, manufactured by SHIMADZU Corp.) to measure tensile force. The tensile force indicates frictional force between (i) the plate 16 which had been coated with Silverstone and (ii) the measuring sample 1. A pin pull-out resistance was then calculated by using a measurement result, based on the following expression:

Pin pull-out resistance=F×1,000/9.80665/1,800

where F(N) is a tensile force measured at a point which is 10 mm away from a start point.

The sleigh member 15 was pulled by using a string (SuperCast PE Nage 2nd, manufactured by SUNLINE Co., Ltd).

<Examples and Comparative Examples of Nonaqueous Electrolyte Secondary Battery Separators>

Nonaqueous electrolyte secondary battery separators, each of which is a porous film, in accordance with respective Examples 1 through 4 and Comparative Examples 1 through 3 were prepared as below.

### Example 1

First, 78% by weight of an ultra-high-molecular-weight polyethylene powder (GUR2024, manufactured by Ticona) and 32% by weight of a polyethylene wax (FNP-0115, manufactured by Nippon Seiro Co., Ltd.) that had a weight-average molecular weight of 1,000 were prepared, i.e., 100 parts by weight in total of the ultra-high-molecular-weight polyethylene and the polyethylene wax were prepared. Then, 0.4% by weight of an antioxidant (Irg1010, manufactured by Ciba Specialty Chemicals), 0.1% by weight of another antioxidant (P168, manufactured by Ciba Specialty Chemicals), and 1.3% by weight of sodium stearate were added to the ultra-high-molecular-weight polyethylene and the polyethylene wax, and then calcium carbonate (manufactured by Maruo Calcium Co., Ltd.) having an average bore diameter of 0.1 μm was further added by 38% by volume with respect to a total volume of these compounds. Then, these compounds were mixed in a state of powder by a Henschel mixer, and were then melted and kneaded by a biaxial kneader, and thus a polyolefin resin composition was obtained. Then, the polyolefin resin composition was rolled by using three pressure rolls R1, R2, and R3 each having a surface temperature of 150° C. Specifically, the polyolefin resin composition was first rolled by using the pressure rolls R1 and R2, and was subsequently rolled by using the pressure rolls R2 and R3. Then, the polyolefin resin composition thus rolled was gradually cooled while being pulled at a draw ratio (speed of winding roll/speed of pressure rolls) of 1.4-fold by using a winding roll that rotates at a speed different from the three pressure rolls R1, R2, and R3. A sheet, having a thickness of approximately 64 μm, was thus prepared. This sheet was immersed in a hydrochloric acid aqueous solution (4 mol/L of hydrochloric acid, 0.5% by weight of a nonionic surfactant) to remove calcium carbonate, and was then drawn 6.2-fold at 100° C. A nonaqueous electrolyte secondary battery separator, which is a porous film, of Example 1 was thus prepared.

### Example 2

First, 71.5% by weight of an ultra-high-molecular-weight polyethylene powder (CUR4032, manufactured by Ticona) and 28.5% by weight of a polyethylene wax (FNP-0115, manufactured by Nippon Seiro Co., Ltd.) that had a weight-average molecular weight of 1,000 were prepared, i.e., 100 parts by weight in total of the ultra-high-molecular-weight polyethylene and the polyethylene wax were prepared. Then, 0.4% by weight of an antioxidant (Irg1010, manufactured by Ciba Specialty Chemicals). 0.1% by weight of another antioxidant (P168, manufactured by Ciba Specialty Chemicals), and 1.3% by weight of sodium stearate were added to the ultra-high-molecular-weight polyethylene and the polyethylene wax, and then calcium carbonate (manufactured by Maruo Calcium Co., Ltd.) having an average bore diameter of 0.1 μm was further added by 37% by volume with respect to a total volume of these compounds. Then, these compounds were mixed in a state of powder by a Henschel mixer, and were then melted and kneaded by a biaxial kneader, and thus a polyolefin resin composition was obtained. Then, the polyolefin resin composition was rolled by using three pressure rolls R1, R2, and R3 each having a surface temperature of 150° C. Specifically, the polyolefin resin composition was first rolled by using the pressure rolls R1 and R2, and was subsequently rolled by using the pressure rolls R2 and R3. Then, the polyolefin resin composition thus rolled was gradually cooled while being pulled at a draw ratio (speed of winding roll/speed of pressure rolls) of 1.4-fold by using a winding roll that rotates at a speed different from the three pressure rolls R1, R2, and R3. A sheet, having a thickness of approximately 70 μm, was thus prepared. This sheet was immersed in a hydrochloric acid aqueous solution (4 mol/L of hydrochloric acid, 0.5% by weight of a nonionic surfactant) to remove calcium carbonate, and was then drawn 7.0-fold at. 100° C. A nonaqueous electrolyte secondary battery separator, which is a porous film, of Example 2 was thus prepared.

### Example 3

First, 70% by weight of an ultra-high-molecular-weight polyethylene powder (GUR4032, manufactured by Ticona) and 30% by weight of a polyethylene wax (FNP-0115, manufactured by Nippon Seiro Co., Ltd.) that had a weight-average molecular weight of 1,000 were prepared, i.e., 100 parts by weight in total of the ultra-high-molecular-weight polyethylene and the polyethylene wax were prepared. Then, 0.4% by weight of an antioxidant (Irg1010, manufactured by Ciba Specialty Chemicals), 0.1% by weight of another antioxidant (P168, manufactured by Ciba Specialty Chemicals), and 1.3% by weight of sodium stearate were added to the ultra-high-molecular-weight polyethylene and the polyethylene wax, and then calcium carbonate (manufactured by Maruo Calcium Co. Ltd.) having an average bore diameter of 0.1 μm was further added by 36% by volume with respect to a total volume of these compounds. Then, these compounds were mixed in a slate of powder by a Henschel mixer, and were then melted and kneaded by a biaxial kneader, and thus a polyolefin resin composition was obtained. Then, the polyolefin resin composition was rolled by a pair of rolls having a surface temperature of 150° C., and then gradually cooled while being pulled at a draw ratio (speed of winding roll/speed of pressure rolls) of 1.4-fold by using a winding roll that rotates at a speed different from that of the pair of rolls. A single-layer sheet, having a thickness of approximately 41 μm, was thus prepared. Subsequently, another single-layer sheet, having a thickness of approximately 44 μm, was produced in a similar manner. The two types of single-layer sheets thus prepared were pressure-bonded by a pair of rollers having a surface temperature of 150° C., and were then gradually cooled while being pulled at a draw ratio (speed of winding roll/speed of pressure rolls) of 1.4-fold by using a winding roll that rotates at a speed different from that of the pair of rolls. A laminated sheet, having a thickness of approximately 67 μm, was thus prepared. This laminated sheet was immersed in a hydrochloric acid aqueous solution (4 mol/L of hydrochloric acid, 0.5% by weight of a nonionic surfactant) to remove calcium carbonate, and was then drawn 6.2-fold at 105° C. A nonaqueous electrolyte secondary battery separator, which is a porous film, of Example 3 was thus prepared.

### Example 4

First, 71.5% by weight of an ultra-high-molecular-weight polyethylene powder (GUR4032, manufactured by Ticona) and 28.5% by weight of a polyethylene wax (FNP-0115, manufactured by Nippon Seiro Co., Ltd.) that had a weight-average molecular weight of 1,000 were prepared, i.e., 100 parts by weight in total of the ultra-high-molecular-weight polyethylene and the polyethylene wax were prepared. Then, 0.4% by weight of an antioxidant (Irg1010, manufactured by Ciba Specialty Chemicals), 0.1% by weight of another antioxidant (P168, manufactured by Ciba Specialty Chemicals), and 1.3% by weight of sodium stearate were added to the ultra-high-molecular-weight polyethylene and the polyethylene wax, and then calcium carbonate (manufactured by Maruo Calcium Co., Ltd.) having an average bore diameter of 0.1 μm was further added by 37% by volume with respect to a total volume of these compounds. Then, these compounds were mixed in a state of powder by a Henschel mixer, and were then melted and kneaded by a biaxial kneader, and thus a polyolefin resin composition was obtained. Then, the polyolefin resin composition was rolled by using three pressure rolls R1, R2, and R3 each having a surface temperature of 150° C. Specifically, the polyolefin resin composition was first rolled by using the pressure rolls R1 and R2, and was subsequently rolled by using the pressure rolls R2 and R3. Then, the polyolefin resin composition thus rolled was gradually cooled while being pulled at a draw ratio (speed of winding roll/speed of pressure rolls) of 1.4-fold by using a winding roll that rotates at a speed different from the three pressure rolls R1, R2, and R3. A sheet, having a thickness of approximately 100 μm, was thus prepared. This sheet was immersed in a hydrochloric acid aqueous solution (4 mol/L of hydrochloric acid, 0.5% by weight of a nonionic surfactant) to remove calcium carbonate, and was then drawn 5.8-fold at 105° C. A nonaqueous electrolyte secondary battery separator, which is a porous film, of Example 4 was thus prepared.

### Comparative Example 1

First, 70% by weight of an ultra-high-molecular-weight polyethylene powder (GUR4032, manufactured by Ticona) and 30% by weight of a polyethylene wax (FNP-0115, manufactured by Nippon Seiro Co., Ltd.) that had a weight-average molecular weight of 1,000 were prepared, i.e., 100 parts by weight in total of the ultra-high-molecular-weight polyethylene and the polyethylene wax were prepared. Then, 0.4% by weight of an antioxidant (Irg1010, manufactured by Ciba Specialty Chemicals), 0.1% by weight of another antioxidant (P168, manufactured by Ciba Specialty Chemicals), and 1.3% by weight of sodium stearate were added to the ultra-high-molecular-weight polyethylene and the polyethylene wax, and then calcium carbonate (manufactured by Maruo Calcium Co., Ltd.) having an average bore diameter of 0.1 μm was further added by 36% by volume with respect to a total volume of these compounds. Then, these compounds were mixed in a state of powder by a Henschel mixer, and were then melted and kneaded by a biaxial kneader, and thus a polyolefin resin composition was obtained. Then, the polyolefin resin composition was rolled by using a pair of rolls each having a surface temperature of 150° C., and then gradually cooled while being pulled at a draw ratio (speed of winding roll/speed of pressure rolls) of 1.4-fold by using a winding roll that rotates al a speed different from the pair of rolls. A single-layer sheet having a thickness of approximately 29 μm was thus prepared. Subsequently, another single-layer sheet having a thickness of approximately 34 μm was prepared in a similar manner. The two types of single-layer sheets thus obtained were pressure-bonded by using a pair of rollers each having a surface temperature of 150° C., and then gradually cooled while being pulled at a draw ratio (speed of winding roll/speed of pressure rolls) of 1.4-fold by using a winding roll that rotates at a speed different from the pair of rolls. A laminated sheet having a thickness of approximately 51 μm was thus prepared. This laminated sheet was immersed in a hydrochloric acid aqueous solution (4 mol/L of hydrochloric acid, 0.5% by weight of a nonionic surfactant) to remove calcium carbonate, and then drawn 6.2-fold at 105° C. A nonaqueous electrolyte secondary battery separator, which is a porous film, of Comparative Example 1 was thus prepared.

### Comparative Example 2

A commercially-available polyolefin porous film (polyolefin separator) was employed as a nonaqueous electrolyte secondary battery separator of Comparative Example 2.

Table 1 shows evaluation results of properties with regard to respective of the nonaqueous electrolyte secondary battery separators (porous films) of respective Examples 1 through 4 and Comparative Examples 1 and 2.

TABLE 1

| | | | | | Pin pull-out test | | |
|---|---|---|---|---|---|---|---|
| | | | | | | Amount by which | |
| | | | | | | width changed | |
| | Thickness | Porosity | Height* | Cutting | Pull-out | through pin pull-out | Pin pull-out |
| | (μm) | (%) | (cm) | processibility | sensitivity | test (mm) | resistance |
| Example 1 | 10.9 | 37 | 65 | Good | Good | 0.04 | 0.09 |
| Example 2 | 11.9 | 51 | 80 | Good | Good | 0.02 | 0.09 |
| Example 3 | 16.5 | 54 | 90 | Good | Good | 0.04 | 0.08 |
| Example 4 | 19.1 | 43 | 120 | Good | Good | 0.02 | 0.08 |
| Comparative | 16.5 | 65 | 35 | Good | Moderate | 0.20 | 0.17 |
| Example 1 | | | | | | | |
| Comparative | 24.3 | 53 | 35 | Bad | Bad | 0.33 | 0.15 |
| Example 2 | | | | | | | |

*Note that “Height” refers to a minimum height from which a ball is made to free-fall on the porous film, so that the porous film is caused to be torn.

As shown in Table 1, each of the nonaqueous electrolyte secondary battery separators (porous films) of respective Examples 1 through 4 had a thickness of 20 μm or less and a porosity of 20% to 55%. With regard to Example 1 through 4, it was confirmed that a minimum height at which a porous film is caused to be destroyed in a falling-ball test was not less than 50 cm. Each of the porous films of respective Examples 1, 2, and 4 has a single layer, so as to have a large thickness before it is rolled. Because of this, the porous films of respective Examples 1, 2, and 4 each appear to contain a lower proportion of skin layer than those of Comparative Examples. Furthermore, the porous film, which has a large thickness before it is rolled, is rolled twice by using three pressure rolls. This causes molecules not to become more oriented in the MD than in the TD, and ultimately causes excellent balance of molecular orientation between the MD and the TD. Because of this, the minimum height appears to be not less than 50 cm. Although the porous film of Example 3 is composed of two single layers, each of them has a large thickness. Because of this, a proportion of a skin layer is lower than those of Comparative Examples, and excellent balance of molecular orientation between the MD and the TD is therefore realized. This appears to cause the minimum height to not be less than 50 cm.

With regard to each of the porous films of respective Examples 1 through 4 in each of which the minimum height, at which the porous film is caused to be destroyed in a falling-ball test, was not less than 50 cm, it was confirmed that (i) cutting processibility and pull-out sensibility were Good, and (ii) before and after the stainless steel ruler was pulled out, a variation of the width was 0.04 or less. This is because (i) each of the porous films of respective Examples 1 through 4 contains a lower proportion of skin layer than those of Comparative Examples 1 and 2, in each of which the minimum height, at which the porous film is caused to be destroyed in a falling-ball test, was less than 50 cm, and (ii) balance of molecular orientation between the MD and the TD fell in an appropriate range in each of the porous films of respective Examples 1 through 4.

Each of the porous films of Examples 1 through 4 had a pin pull-out resistance of 0.1 or less. In contrast, each of the porous films of respective Comparative Examples had a pin pull-out resistance of exceeding 0.1. The values of the pin pull-out resistance are correlated to results of the pin pull-out test. It is therefore understandable that each of the pin pull-out resistance indicates how a pin is apt to be pulled out during assembly of a nonaqueous electrolyte secondary battery of winding-type.

As such, in a case where the minimum height, at which the porous film is caused to be destroyed in a falling-ball test, was not less than 50 cm, excellent cutting processability was realized. In such a case, it was also confirmed that slip characteristics with respect to pins during assembly of the nonaqueous electrolyte secondary battery of winding type was also excellent.

<Examples and Comparative Examples of Nonaqueous Electrolyte Secondary Battery Laminated Separator>

Nonaqueous electrolyte secondary battery laminated separators in accordance with respective Examples 5 through 7 and Comparative Example 3 were prepared as below.

(Adjustment of Coating Solution)

Poly(paraphenylene terephthalamide) (para-aramid) was prepared as below by using a separable flask having a capacity of 3 liter (L) and having a stirring blade, a thermometer, a nitrogen inlet tube, and a powder addition port. First, the flask was sufficiently dried, and was infused with 2,200 g of N-methyl-2-pyrrolidone (NMP). Subsequently, 151.07 g of calcium chloride powder that had been vacuum-dried for 2 hours at 200° C. was added to the NMP. The temperature of the NMP was raised to 100° C. to completely dissolve the calcium chloride powder. A resultant mixture was cooled to a room temperature, and 68.23 g of paraphenylenediamine was added and completely dissolved. While a resultant solution was kept at 20° C.±2° C., 124.97 g of terephthalic acid dichloride, that had been divided into 10 equal portions, was added at approximately 5-minute intervals. Thereafter, the solution was allowed to mature for 1 hour while being stirred and kept at 20° C.±2° C. A matured solution was filtered by using a stainless steel gauze of 1,500 mesh. A solution thus obtained had a para-aramid concentration of 6%. 100 g of this para-aramid solution was infused in another flask, and 300 g of NMP was added, such that the solution had a para-aramid concentration of 1.5% by weight. The solution was then stirred for 60 minutes. To the solution having a para-aramid concentration of 1.5% by weight, 6 g of Alumina C (manufactured by Nippon Aerosil Co., Ltd.) and 6 g of Advanced Alumina AA-03 (manufactured by Sumitomo Chemical Co., Ltd.) were added, and a resultant solution was stirred for 240 minutes. A solution thus obtained was filtered by using a metallic gauze of 1,000 mesh. Thereafter, 0.73 g of calcium oxide was added to a filtrate thus obtained, followed by 240 minutes of stirring to achieve neutralization. A solution thus neutralized was subjected to deformation under reduced pressure. A coating solution in a slurry form was thus prepared.

### Example 5

A porous film of Example 2 was fixed onto a PET film having a thickness of 100 μm, and one side of the porous film thus fixed was coated with the coating solution, which had a slurry form, by using a bar coater. The porous film on the PET film and a coated film thus formed on the porous film were immersed together in water, which is a poor solvent, to precipitate a porous layer (heat-resistant layer) made of para-aramid. Subsequently, the porous film was dried to remove the solvent, and the PET film was removed to prepare a nonaqueous electrolyte secondary battery laminated separator, of Example 5, which includes the porous film and the porous layer that is laminated to one side of the porous film.

### Example 6

A porous film of Example 3 was fixed onto a PET film having a thickness of 100 μm, and one side of the porous film thus fixed was coated with the coating solution, which had a slurry form, by using a bar coater. The porous film on the PET film and a coated film thus formed on the porous film were immersed together in water, which is a poor solvent, to precipitate a porous layer (heat-resistant layer) made of para-aramid. Subsequently, the porous film was dried to remove the solvent, and the PET film was removed to prepare a nonaqueous electrolyte secondary battery laminated separator, of Example 6, which includes the porous film and the porous layer that is laminated to one side of the porous film.

### Example 7

A porous film of Example 4 was fixed onto a PET film having a thickness of 100 μm, and one side of the porous film thus fixed was coated with the coating solution, which had a slurry form, by using a bar coater. The porous film on the PET film and a coated film thus formed on the porous film were immersed together in water, which is a poor solvent, to precipitate a porous layer (heat-resistant layer) made of para-aramid. Subsequently, the porous film was dried to remove the solvent, and the PET film was removed to prepare a nonaqueous electrolyte secondary battery laminated separator, of Example 7, which includes the porous film and the porous layer that is laminated to one side of the porous film.

### Comparative Example 3

A porous film of Comparative Example 1 was fixed onto a PET film having a thickness of 100 μm, and one side of the porous film thus fixed was coated with the coating solution, which had a slurry form, by using a bar coater. The porous film on the PET film and a coated film thus formed on the porous film were immersed together in water, which is a poor solvent, to precipitate a porous layer (heat-resistant layer) made of para-aramid. Subsequently, the porous film was dried to remove the solvent, and the PET film was removed to prepare a nonaqueous electrolyte secondary battery laminated separator, of Comparative Example 3, which includes the porous film and the porous layer that is Laminated to one side of the porous film.

Table 2 shows evaluation results of properties with regard to respective of the nonaqueous electrolyte secondary battery laminated separators of respective Examples 5 through 7 and Comparative Example 3. Note that the nonaqueous electrolyte secondary battery laminated separators of respective Examples 5 through 7 and Comparative Example 3 have pin pull-out resistances substantially identical to those of relevant nonaqueous electrolyte secondary battery separators that are composed of respective porous films included in the nonaqueous electrolyte secondary battery laminated separators (i.e., pin pull-out resistances identical to those in Examples 2 through 4 and Comparative Example 1). Thus, pin pull-out resistances are omitted in Table 2.

TABLE 2

| | Weight per | | | Pin pull-out test | |
|---|---|---|---|---|---|
| | unit area of | | | | Amount by which width |
| | porous layer | Height* | Cutting | Pull-out | changed through pin |
| | (g/m²) | (cm) | processibility | sensitivity | pull-out test (mm) |
| Example 5 | 2.9 | 60 | Good | Good | 0.02 |
| Example 6 | 3.1 | 80 | Good | Good | 0.00 |
| Example 7 | 3.2 | 60 | Good | Good | 0.01 |
| Comparative | 3.0 | 40 | Good | Moderate | 0.13 |
| Example 3 | | | | | |

*Note that “Height” refers to a minimum height from which a ball is made to free-fall on the nonaqueous electrolyte secondary battery laminated separator, so that the nonaqueous electrolyte secondary battery laminated separator is caused to be torn.

As shown in Table 2, with regard to the nonaqueous electrolyte secondary battery laminated separators of Examples 5 through 7, it was confirmed that (i) the minimum height, at which the nonaqueous electrolyte secondary battery laminated separator is caused to be destroyed in a falling-ball test, was not less than 50 cm, and (ii) excellent cutting processability was realized. In such a case, it was also confirmed that slip characteristics with respect to pins during assembly of the nonaqueous electrolyte secondary battery of winding type was also excellent.

<Experiment on Friction Coefficient of Ball Surface>

For reference, the falling-ball test was carried out by using balls (mirror-finished ball and non-mirror-finished ball) with different surface roughnesses (friction coefficients) to clarify that a friction coefficient of a ball surface is not related to the results of the falling-ball test.

(Method of Experiment)

(1) Evaluation of Surface Roughness of Ball

Each surface roughness (Ra) of the mirror-finished ball and non-mirror-finished ball was measured, by using a non-contact surface measurement system (VertScan™ 2.0 R5500GML, manufactured by Ryoka systems Inc.), under the following conditions:

Measurement conditions:

Object lens: 5-fold magnification (Michelson-type)

Intermediate lens: 1-fold magnification

Wavelength filter: 530 nm

CCD camera: ⅓ inch

Measurement mode: Wave

Data correction: Spherical approximation with radius of 7.15 mm

(2) Falling-Ball Test

Each separator of Test Examples 1 through 4, which will be later described, was subjected to the falling-ball test in a manner similar to the method described in “(3) Falling-ball test” of “<Method for measuring various physical properties>”, except that bolls (mirror-finished ball and non-mirror-finished ball) with respective different surface roughnesses were used.

### Test Example 1

A nonaqueous electrolyte secondary battery separator prepared as with Example 1 was subjected to the falling-ball test using a mirror-finished ball.

### Test Example 2

A nonaqueous electrolyte secondary battery separator prepared as with Example 1 was subjected to the falling-ball test using a non-mirror-finished ball.

### Test Example 3

A nonaqueous electrolyte secondary battery laminated separator prepared as with Example 5 was subjected to the falling-ball test using a mirror-finished ball.

### Test Example 4

A nonaqueous electrolyte secondary battery laminated separator prepared as with Example 5 was subjected to the falling-ball test using a non-mirror-finished ball.

(Experimental Results)

(1) Evaluation of Surface Roughness of Ball

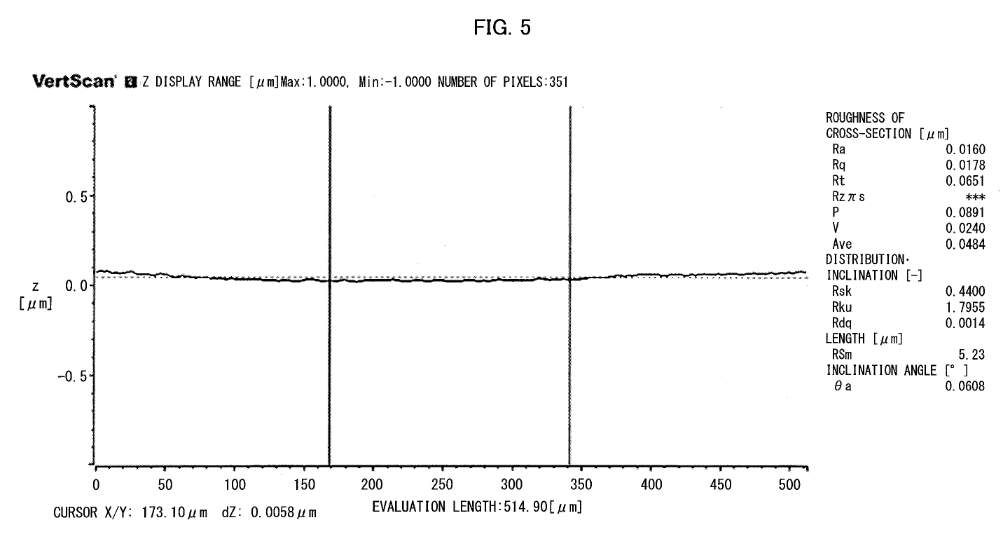

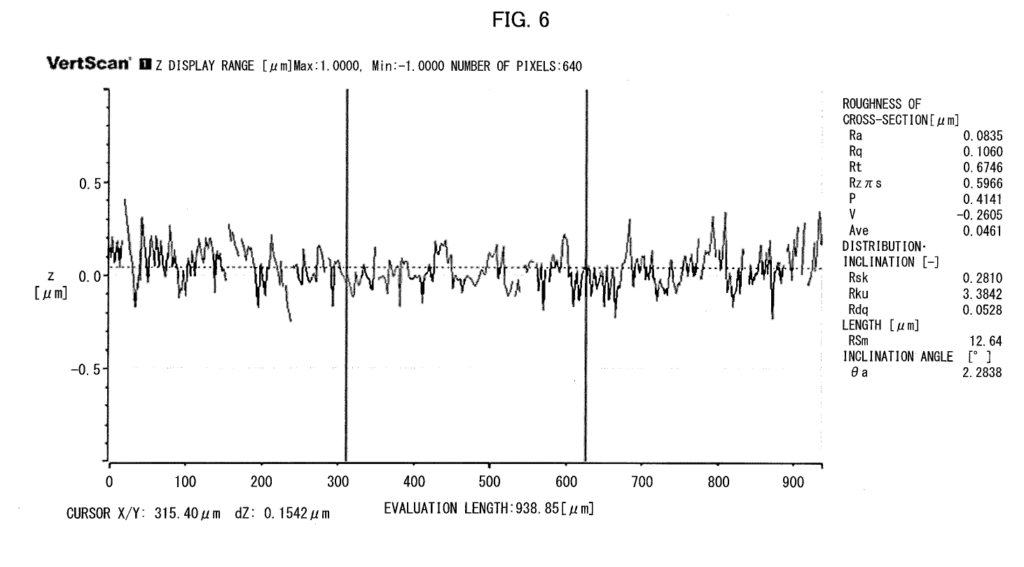

FIGS. 5 and 6 show measurement results of surface roughnesses of respective mirror-finished ball and non-mirror-finished ball, which measurement results were obtained by using the non-contact surface measurement system. FIGS. 5 and 6 reveal that the mirror-finished ball and the non-mirror-finished ball had respective different surface roughnesses.

(2) Falling-Ball Test

Table 3 shows results of the falling-ball test, together with the surface roughnesses obtained by the non-contact surface measurement system.

TABLE 3

| | Separator | Ball (surface roughness) | Height* |
|---|---|---|---|
| Test | Same as | Mirror-finished ball | 65 cm |
| Example 1 | Example 1 | (Ra = 0.016 μm) | |
| Test | Same as | Non-mirror-finished ball | 65 cm |
| Example 2 | Example 1 | (Ra = 0.084 μm) | |
| Test | Same as | Mirror-finished ball | 60 cm |
| Example 3 | Example 5 | (Ra = 0.016 μm) | |
| Test | Same as | Non-mirror-finished ball | 60 cm |
| Example 4 | Example 5 | (Ra = 0.084 μm) | |

*Note that “Height” refers to a minimum height from which a ball is made to free-fall on the porous film or the nonaqueous electrolyte secondary battery laminated separator, so that the porous film or the nonaqueous electrolyte secondary battery laminated separator is caused to be torn.

As is clear from a comparison between Teat Examples 1 and 2, results of the falling-ball tests carried out with respect to a separator identical to that of Example 1 were identical to each other, irrespective of whether the mirror-finished ball or the non-mirror-finished ball was used. Similarly, as is clear from a comparison between Test Examples 3 and 4, results of the falling-ball tests carried out with respect to a separator identical to that of Example 5 were identical to each other, irrespective of whether the mirror-finished ball or the non-mirror-finished ball is used.

That is, results of the falling-ball test do not affected by the surface roughness of a ball (i.e., friction coefficient of ball surface).

1. A nonaqueous electrolyte secondary battery separator being a porous film containing polyolefin as a major component,
the porous film having a thickness of 20 μm or less and having a porosity of 20% to 55%,
a minimum height from which a ball, with a diameter of 14.3 mm and a weight of 11.9 g, is made to free-fall on the porous film, so that the porous film is caused to be torn, being not less than 50 cm.

2. A nonaqueous electrolyte secondary battery member comprising:
a cathode;
a nonaqueous electrolyte secondary battery separator recited in claim 1; and
an anode,
the cathode, the nonaqueous electrolyte secondary battery separator, and the anode being provided in this order.

3. A nonaqueous electrolyte secondary battery comprising:
a nonaqueous electrolyte secondary battery separator recited in claim 1.

4. A nonaqueous electrolyte secondary battery laminated separator comprising:
a nonaqueous electrolyte secondary battery separator recited in claim 1; and
a porous layer.

5. A nonaqueous electrolyte secondary battery member comprising:
a cathode;
a nonaqueous electrolyte secondary battery laminated separator recited in claim 4; and
an anode,
the cathode, the nonaqueous electrolyte secondary battery laminated separator, and the anode being provided in this order.

6. A nonaqueous electrolyte secondary battery comprising;
a nonaqueous electrolyte secondary battery laminated separator recited in claim 4.

7. A nonaqueous electrolyte secondary battery laminated separator comprising a porous film and a porous layer, the porous film containing polyolefin as a major component,
the porous film having a thickness of 20 μm or less and having a porosity of 20% to 55%,
a minimum height from which a ball, with a diameter of 14.3 mm and a weight of 11.9 g, is made to free-fall on the nonaqueous electrolyte secondary battery laminated separator, so that the nonaqueous electrolyte secondary battery laminated separator is caused to be torn, being not less than 50 cm.

8. A nonaqueous electrolyte secondary battery member comprising:
a cathode;
a nonaqueous electrolyte secondary battery laminated separator recited in claim 7; and
an anode,
the cathode, the nonaqueous electrolyte secondary battery laminated separator, and the anode being provided in this order.

9. A nonaqueous electrolyte secondary battery comprising:
a nonaqueous electrolyte secondary battery laminated separator recited in claim 7.
